(19) United States
(12) Patent Application Publication
(10) Pub. No.: US 2010/0330268 A1
(43) Pub. Date: Dec. 30, 2010

(54) BATTERIES, ELECTRODES FOR BATTERIES, AND METHODS OF THEIR MANUFACTURE

(75) Inventor: Zhiping Jiang, Westford, MA (US)

Correspondence Address: FISH & RICHARDSON P.C., P.O. BOX 1022, MINNEAPOLIS, MN, 55440-1022, US

(73) Assignee: The Gillette Company

(21) Appl. No.: 12/880,526

(22) Filed: Sep. 13, 2010

Related U.S. Application Data
(62) Division of application No. 11/493,455, filed on Jul. 26, 2006.

(51) Int. Cl. B05D 5/12

(52) U.S. Cl. 427/78

(57) ABSTRACT

Lithium batteries are disclosed in which the battery separator is formed directly on one of the electrodes, e.g., the positive electrode. The battery separator comprises silica particles dispersed in a polymeric matrix. Battery electrodes with an integral battery separator are also disclosed, as are methods of forming such electrodes and batteries containing such electrodes.

### CROSS-REFERENCE TO RELATED APPLICATION

This application is a divisional application of and claims priority to U.S. Ser. No. 11/493,455, filed on Jul. 26, 2006, which is hereby incorporated by reference.

### TECHNICAL FIELD

This invention relates to batteries, for example lithium batteries, and electrodes for such batteries, and methods of manufacturing batteries and electrodes.

### BACKGROUND

A primary lithium battery is an electrochemical galvanic cell consisting of a positive electrode, a negative electrode, and an ion-conducting separator interposed between the two electrodes. The positive electrode includes a transition metal oxide or sulfide such as MnO₂, V₂O₅, CuO, or FeS₂, or a material such as carbon fluoride, sulfur dioxide and thionyl chloride. The negative electrode can include a lithium, lithium alloy, or other Li-containing material. A thin, porous membrane is generally used as the separator, for example a polyolefin film, glass fiber filter paper, or cloth or non-woven fabric sheet. The separator is generally laminated between the electrodes. To achieve adequate mechanical strength, the separator is typically at least 0.001 inch thick, and thus occupies a significant volume in the battery.

In JP 11-345606, it has been proposed to spray a polymeric material onto one of the electrodes of a secondary lithium ion battery to form a layer of porous polymeric material on the electrode that acts as a separator.

### SUMMARY

In one aspect, the invention features a battery that includes a positive electrode and a negative electrode, and, bonded to a surface of one of the electrodes, a porous layer comprising silica particles dispersed in a polymeric matrix.

In some implementations, the polymeric matrix is selected from the group consisting of styrene-isoprene-styrene and polyvinylidene fluoride. The silica particles may in some cases comprise spherical particles having an average particle size of from about 10 to 500 nm. Alternatively, the silica particles may comprise elongated particles having average dimensions of x=10 to 500 nm and y=10 to 500 nm.

In some instances, the battery includes a second porous layer, comprising colloidal silica particles. The second porous layer may be interposed between the electrode and the porous layer that comprises silica particles dispersed in a polymeric matrix.

The battery may be, for example, a primary lithium battery or a secondary lithium-ion battery.

The positive electrode may include a material selected from the group consisting of transition metal oxides, transition metal sulfides, carbon fluoride, sulfur dioxide, and thionyl chloride, and the porous layer may be bonded to the positive electrode.

In some implementations, the polymer exhibits an ultimate elongation of greater than 300%. The layer may include from about 20 to 80% silica by volume, for example about 25 to 65% silica by volume. In some implementations, layer includes at least 50% silica by volume. The layer may have a thickness of about 20 to 50 μm, and a porosity of from about 20 to 50% by volume. In implementations in which the battery includes a second porous layer, the second porous layer may have a thickness of about 1 to 5 μm.

In another aspect, the invention features a method of forming a battery separator directly on an electrode, comprising spraying a solution or dispersion comprising silica particles and a polymer onto the electrode.

In some implementations, the method further includes heating the electrode prior to spraying. The electrode may be heated, for example, to a temperature that is about 20 to 40° C. less than the melting point of the polymer. In some cases the method further comprises evacuating to drive off residual solvent, for example under vacuum, at a temperature that is about 20 to 60° C. lower than the melting point of the polymer. The method may further include, prior to spraying the solution or dispersion onto the electrode, spraying a dispersion consisting essentially of colloidal silica onto the electrode to form an underlying silica layer.

In yet another aspect, the invention features a primary lithium battery comprising a positive electrode, a negative electrode comprising lithium, and a porous layer comprising silica particles bonded to a surface of the negative electrode.

In the separators disclosed herein, the presence of the silica particles significantly enhances the conductivity of the separator, and decreases the crystallinity of the polymer matrix, thereby enhancing the transport of electrolyte species within the polymer matrix. The silica particles also lend mechanical strength to the separator, preventing shorting.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a diagrammatic view showing a process for forming a separator directly on an electrode, according to one implementation.

FIG. 2 is a diagrammatic view showing a process for forming a separator directly onto an electrode, according to another implementation.

FIG. 3 is a graph showing discharge data for 2032 Li/FeS₂ coin cells including the positive electrodes formed as described in Examples 1 and 2.

FIG. 4 is a graph showing discharge data for 2032 LiMnO₂ coin cells including the positive electrodes formed as described in Examples 4 and 5.

FIG. 5 is a graph showing discharge data for 2032 LiFeS2 coin cells including the FeS2 electrode formed as described in Examples 7 and 8.

FIG. 6 is a graph showing charge/discharge data for a 2032 LiMn_{0.33}Ni_{0.33}Co_{0.33}Oₐ coin cell formed as described in Examples 9 and 10.

Like reference symbols in the various drawings indicate like elements.

### DETAILED DESCRIPTION

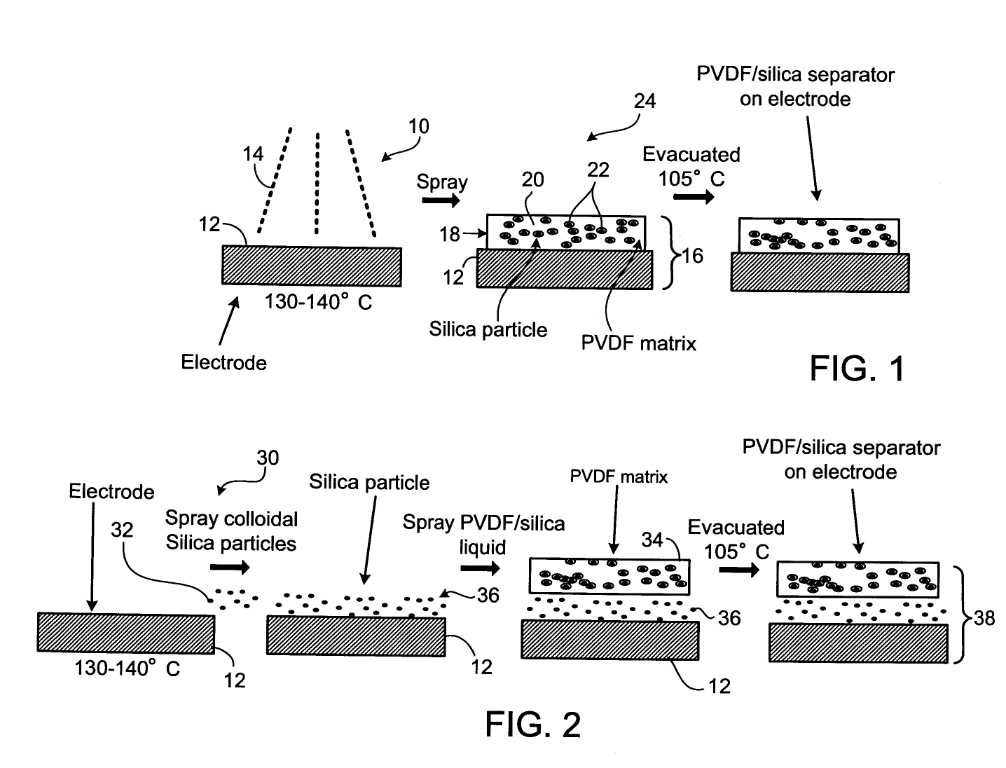

One process for forming a separator directly on a positive electrode is shown in FIG. 1. The positive electrode may be, for example, a transition metal oxide or sulfide such as MnO₂, V₂O₅, CuO, or FeS₂, or a material such as carbon fluoride, sulfur dioxide and thionyl chloride. In the case of the last two systems, the electrodes are based on carbon materials where sulfur dioxide or thionyl chloride is electrochemically reduced. In a first step (10), the electrode (12) is heated, e.g., to a temperature of about 130 to about 140° C., and a liquid coating composition (14) is sprayed onto the electrode. The coating composition includes silica particles dispersed in a non-aqueous polymer solution. The electrode is heated, in step (10), so that the solvent will dry off quickly when the coating is sprayed on the electrode, e.g., within 20 seconds, preferably in less than 5 seconds. The temperature of the electrode is selected so that it is lower than the melting point of the polymer that is used, e.g., 20 to 40° C. lower than the melting point. For example, if polyvinylidene fluoride (PVDF, melting point 160° C.) is used as the polymer, the electrode is preferably heated to about 130 to 140° C. The spraying step and subsequent drying results in a composite electrode/separator (16) that includes the underlying electrode (12) and a porous coating (18) consisting of a matrix (20) of the polymer and the silica particles (22) uniformly dispersed in the matrix. In a final step (24), the coating is evacuated to dry off any remaining solvent within its structure. Evacuation is generally performed at a temperature about 20 to 60° C. lower than the melting point of the polymer, and a vacuum as high as possible, typically below 10 torr. Evacuation times will vary depending on the polymer and solvent used, but are typically in the range of 10-20 hours.

Preferred polymers for the coating include block copolymers, for example polystyrene-isoprene-styrene (SIS) and other block copolymers and elastomers having high elasticity (e.g., an ultimate elongation, measured according to ASTM D412, of greater than 300%, preferably greater than 700% and in some cases 900% or greater).

Another suitable polymer is polyvinylidene fluoride (PVDF). It is generally preferred that the polymer have physical properties that will provide matrix flexibility, particularly if the separator/electrode composite is to be used in a battery the assembly of which requires a high degree of stress and strain, for example the winding of the electrodes in the assembly of AA cells. Generally, it is desirable that the polymer be capable of providing mechanical integrity to the separator layer even at relatively high loadings of silica particles, for example greater than 35% by weight, preferably greater than 60% by weight.

It is also generally necessary that the polymer exhibit chemical compatibility with Li and the cathode material. For ease of processing, it is generally preferred that the polymer be soluble in a low-boiling-point solvent. In some cases, the polymer allows transport of electrolyte species within the matrix. Whether this is the case will depend on the interaction between the polymer and electrolyte that are selected for a particular battery.

Suitable solvents include non-aqueous solvents in which the polymer is soluble and which evaporate relatively quickly under the desired process conditions. When SIS is used as the polymer, suitable solvents include tetrahydrofuran (THF), methyl ethyl ketone (MEK), and mixtures thereof. When PVDF is used as the polymer, suitable solvents include N-methyl-2-pyrrolidinone (NMP), and mixtures of NMP with lower boiling solvents such as THF, MEK, and methyl isobutyl ketone (MIBK). Other solvents may be preferred if a different polymer is used. Generally, it is desirable to use the lowest boiling solvent in which the polymer is soluble. The percent-solids concentration of the solution is typically relatively low, for example about 3 to 30% solids. This concentration generally yields a low viscosity solution that can be easily sprayed. While aqueous solutions may be used with polymers that are water-soluble, they are generally less preferred due to the relatively high boiling point of water and the risk of contaminating the electrode with moisture.

The silica particles preferably have a very small average particle size, on the order of nanometers. In some implementations, the particles have an average particle size of 10 to 500 nm for spherical particles, and dimensions of x=10 to 500 nm, y=10 to 500 nm for elongated particles. The nanoparticles may be supplied in the form of a dispersion, for example in a solvent such as MEK. Suitable nanoparticle dispersions are commercially available, for example, from Nissan Chemical American Corporation. Some preferred nanoparticles are spherical silica particles having a particle diameter of 10 to 15 nm, and elongated particles having a width of 9 to 15 nm and a length of 40 to 300 nm. Preferably, the silica particles are substantially uniformly distributed in the polymer solution.

The volume percentage of the silica particles in the dried and evacuated PVDF/silica composite coating is preferably between 20 and 45%, more preferably between 25 and 40%. For polymers having greater elasticity, such as SIS or other block copolymers, the percentage of silica can be higher, for example from 40 to 80%, and preferably from 50 to 65%. A suitable loading of silica is determined by balancing the need for the separator layer to have good strength and structural integrity against the good porosity and thus ionic conductivity imparted by high levels of silica. Thus, the desired level of silica will be based in large part on the mechanical properties that the selected polymer lends to the separator.

In the resulting separator, the presence of the silica particles significantly enhances the conductivity of the separator, and decreases the crystallinity of the polymer matrix, thereby enhancing the transport of the electrolyte species within the polymer matrix. In some implementations, the separator has a thickness of about 20 to 50 μm, and a porosity of from about 20 to 50% by volume. The porosity can be determined by measuring the actual weight of the coating, and comparing that with the theoretical weight based on its thickness and area.

In an alternative implementation, shown in FIG. 2, the process includes an additional step (30) of spraying a colloidal silica (32), dispersed in a non-aqueous solvent, onto an electrode (12) that has been heated as discussed above. The colloidal silica layer dries upon contact with the heated electrode, and is thereby loosely bound to the surface of the electrode. The colloidal silica particles are preferably also very small, on the order of nanoparticles. The silica particles discussed above are also suitable for use in the colloidal silica layer. Commercially available silica dispersions may be used as-is or diluted with additional solvent to obtain a desired solids level, e.g., 5 to 25% solids, in some implementations about 10 to 15% solids. The desired solids level will depend on process parameters such as viscosity, spraying speed, etc.

After this initial deposition of colloidal silica particles, the process proceeds as discussed above with reference to FIG. 1. Thus, a layer (34) of a polymer solution with silica nanoparticles suspended therein is sprayed onto the layer (36) of colloidal silica particles and evacuated to form the finished electrode/separator composite (38). While not wishing to be bound by theory, it is believed that some of the polymer matrix (e.g., PVDF or SIS) penetrates into the underlying silica layer (the deposited colloidal silica) to contact the electrode, thereby providing adhesion between the colloidal silica and the electrode. The underlying silica layer tends to minimize the amount of the polymer that penetrates into the pores of the electrode, which is advantageous since penetration of polymer into the pores of the electrode can tend to reduce ionic transport.

The resulting two-layer separator structure provides excellent rate capability, typically higher than is achieved with the single-layer separator/electrode composite (16) described above. In some implementations, in the finished separator/electrode composite the layer (36) of colloidal silica particles has a thickness of from about 1 to 5 μm and the layer (34) of PVDF/silica has a thickness of from about 20 to 40 μm. In some implementations, the porosity of the structure as a whole is from about 20 to 50%.

### EXAMPLES

### Example 1

15 g of PVDF (Grade 711; Atofina) was mixed with 67.5 g of NMP and 67.5 g of MEK. The mixture was stirred at ˜70° C. until the PVDF was completely dissolved, forming a 10% (w/w) PVDF solution. 10 g of the PVDF solution was then mixed with 1.60 g of a colloidal silica dispersed in MEK (Grade MEK-ST-UP; Nissan Chemical America Corporation. Content of the silica in the colloid: 20%; average particle sizes: elongated particles having a diameter of 9-15 nanometers with a length of 40-300 nm) by stirring, forming a clear liquid which was used as the precursor for the PVDF/silica separator.

A 2″×5″ piece of ˜5 mil-thick FeS₂ electrode was placed onto a hot plate preheated with a surface temperature of 165° C. The electrode had a composition of 86% FeS₂-7% polystyrene-block-poly(ethylene-ran-butylene)-block-polystyrene (KRATON® G)-7% carbon, supported on a 1.2 mil-thick Al foil. When the surface temperature of the electrode reached 140° C., 1.0 g of a liquid of 50 MEK:50 MEK-ST-UP (w/w) was sprayed onto the electrode using an H-type airbrush (Paasche Air Brush Company) for 15 sec. During the spraying, an air pressure of 40 psi was used. Then, 2.0 g of the liquid containing silica particles and PVDF was sprayed onto the FeS₂ for 1 min. The electrode was subsequently transferred to a 105° C. oven and evacuated for 16 h to dry off solvent remaining in the electrode.

### Example 2

A 10% (w/w) PVDF solution was formed as described in Example 1. 10 g of the PVDF solution was then mixed with 3.75 g of the colloidal silica dispersion used in Example 1 by stirring, forming a clear liquid which was used as the precursor for the PVDF/silica separator.

An electrode was coated using the same procedures described in Example 1, except that 2.5 g of the liquid containing silica particles and PVDF was sprayed onto the FeS₂ for 1 min and 30 sec. As in Example 1, the electrode was subsequently transferred to a 105° C. oven and evacuated for 16 h to dry off solvent remaining in the electrode.

### Example 3

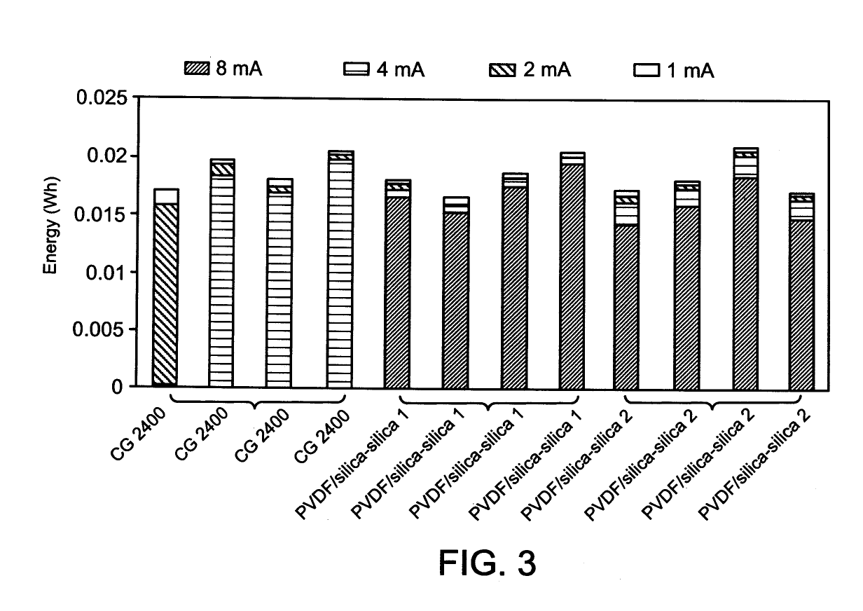

The electrochemical performance of the FeS₂ electrode coated with the PVDF/silica-silica separators was evaluated in 2032 Li/FeS₂ coin cells. The 2032 cells were assembled by laminating a piece of 8 mil-thick Li foil (diameter: 9/16″) with one of the FeS₂ electrodes coated with the PVDF/silica-silica separator (diameter: 7/16″). An electrolyte of 1M LiI in a mixture of 1,2 dimethoxyethane and 1,3 dioxolane (v/v=45/55) was used. The discharge performance of the resultant Li/FeS₂ cells was evaluated by intermittently discharging the cells at the current of 8, 4, 2 and 1 mA to the voltage cutoff of 0.6 V (the cells were rested for 2 h between the discharges). The energy achieved from the discharges at each current are displayed in FIG. 3, in which the electrode/separator composite of Example 1 is labeled “PVDF/silica-silical” and the composite of Example 2 is labeled “PVDF/silica-silica2.” For the purpose of comparison, the 2032 Li cells based on the uncoated FeS₂ electrode and a Celgard 2400 separator were assembled, and the discharge data of these cells are shown in FIG. 3 as well.

### Example 4

A 10% (w/w) PVDF solution was formed as described in Example 1. 10 g of the PVDF solution was then mixed with 2.5 g of a colloidal silica dispersed in MBIK (Grade MIBK-ST; Nissan Chemical America Corporation. Content of the silica in the colloid: 30%; average size of the spherical silica particles: 10-15 nanometers) by stirring, forming a clear liquid which was used as the precursor for the PVDF/silica separator.

A 2″×5″ piece of ˜6 mil-thick MnO₂ electrode was placed onto a hot plate preheated to a surface temperature of 165° C. The electrode had a composition of 86% MnO₂-7% KRATON® G binder -7% carbon, supported on 1.2 mil-thick Al-foil. When the surface temperature of the electrode reached 140° C., 0.75 g of a mixture of 50 MIBK:50 MIBK-ST (w/w) was sprayed onto the electrode using an H-type airbrush (Paasche Air Brush Company) for 10 sec. During the spraying, an air pressure of 40 psi was used. Then, 1.6 g of the liquid containing silica particles and PVDF was sprayed onto the MnO₂ electrode for 25 sec. The electrode was subsequently transferred to a 105° C. oven and evacuated for 16 h to dry off solvent remaining in the electrode.

### Example 5

A 10% (w/w) PVDF solution was formed as described in Example 1. 10 g of the PVDF solution was then mixed with 3.75 g of a colloidal silica dispersed in MEK (Grade MEK-ST-UP; Nissan Chemical America Corporation. Content of the silica in the colloid: 20%; average particle size: elongated particles having a diameter of 9-15 nanometers with a length of 40-300 nm) by stirring, forming a clear liquid which was used as the precursor for the PVDF/silica separator.

A 2″×5″ piece of ˜6 mil-thick MnO₂ electrode was placed onto a hot plate preheated with a surface temperature of 140° C. The electrode had a composition of 86% MnO₂-7% KRATON*1 G binder -7% carbon, supported on 1.2 mil-thick Al-foil . When the surface temperature of the electrode reached 140° C., 1.0 g of a liquid of 50 MEK:50 MEK-ST-UP (w/w) was sprayed onto the electrode using an H-type airbrush (Paasche Air Brush Company) for 10 sec. During the spraying, an air pressure of 40 psi was used. Then, 2.0 g of the liquid containing silica particles and PVDF was sprayed onto the MnO₂ electrode for 25 sec. The electrode was subsequently transferred to a 105° C. oven and evacuated for 16 h to dry off solvent remaining in the electrode.

### Example 6

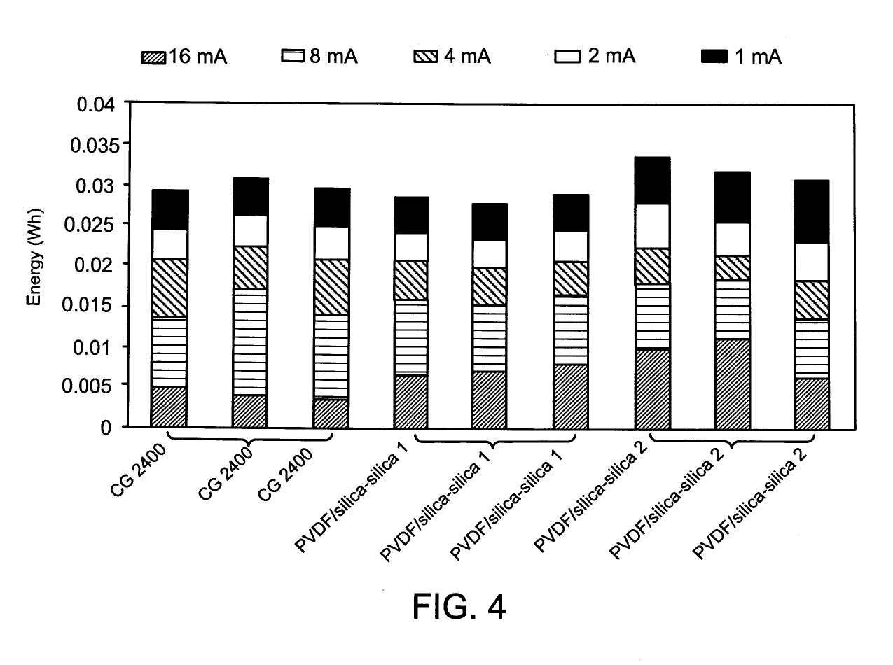

The electrochemical performance of the MnO₂ electrode coated with the PVDF/silica separator was evaluated in 2032 Li/MnO₂ coin cells. The 2032 cells were assembled by laminating a piece of 31 mil-thick Li foil (diameter: 7/16″) with one of the MnO₂ electrode coated with the separator (diameter: 9/16″). A electrolyte containing 11.6% ethylene carbonate-22.8% propylene carbonate-55.6% 1,2 dimethoxyethane-10.0% lithium trifluoromethanesulfonate (WM) was used. The discharge performance of the resultant Li/MnO₂ cells was evaluated by intermittently discharging the cells at a current of 16, 8, 4, 2 and 1 mA to the voltage cutoff of 1.5 V (the cells were rested for 2 h between the discharges). The energy achieved from the discharges are displayed in FIG. 4. For the purpose of comparison, the 2032 Li cells based on the uncoated MnO₂ electrode and a Celgard 2400 separator were assembled, and the discharge data of these cells are shown in FIG. 4.

### Example 7

4 g of SIS (Aldrich Chemical Company) was mixed with 96 g of MEK. The mixture was stirred at 60° C. until the SIS was completely dissolved. When the solution was cooled at room temperature, it became cloudy and eventually formed a liquid that included fine SIS particles suspended in MEK. 6.8 g of this SIS colloid was mixed with 5 g of MEK and 6 g of colloidal silica dispersed in MEK (Grade MEK-ST-UP; Nissan Chemical America Corporation. Content of the silica in the colloid: 20%; average particle size: elongated particles having a diameter of 9-15 nanometers with a length of 40-300 nm), forming a colloidal liquid which was used as the coating formulation for the SIS/silica separator. The solid contents of silica and SIS in this formulation were (v/v) 65% and 35%, respectively.

A 4.1 mm×300 mm piece of ˜3 mil-thick FeS₂ electrode coated on aluminum foil was placed onto a hot plate preheated with a surface temperature of 140° C. The electrode had a composition of 86% FeS₂-7% KRATON-G® binder-7% graphite. When the surface temperature of the electrode reached 100° C., 5.35 g of the above coating formulation was sprayed onto the electrode using an H-type airbrush (Paasche Air Brush Company) under an air pressure of 15 psi. The electrode was subsequently transferred to a 100° C. oven and evacuated for 16 h to dry off solvent remaining in the electrode.

### Example 8

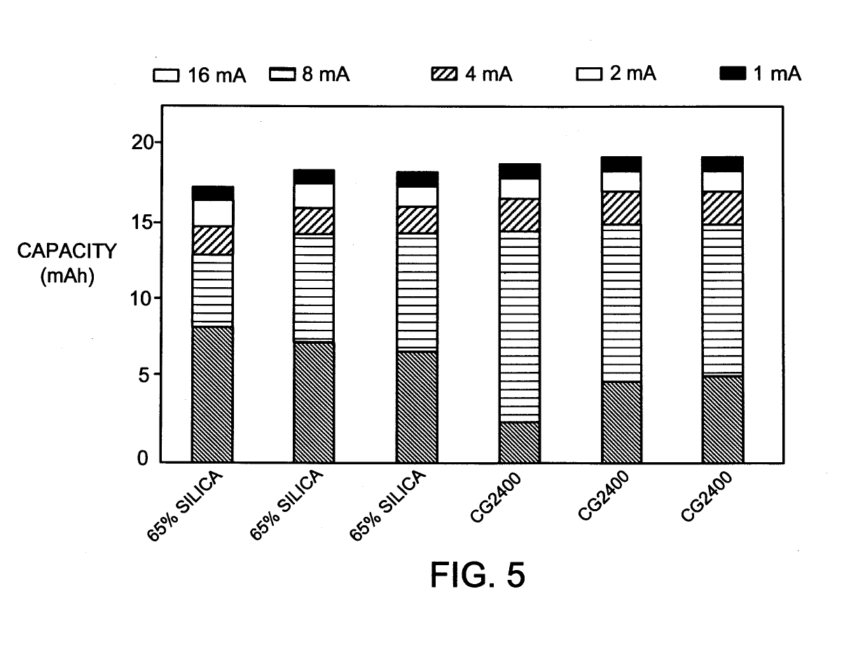

The electrochemical performance of the FeS₂ electrode coated with the silica/SIS separator, described in Example 7, was evaluated in 2032 Li/FeS₂ coin cells. The 2032 cells were assembled by laminating a piece of 31 mil-thick Li foil (diameter: 9/16″) with the FeS₂ electrode coated with the silica/SIS-silica separator (diameter: 7/16″). An electrolyte of 1 M LiI in a mixture of 1,2 dimethoxyethane and 1,3 dioxolane (v/v-45/55) was used. The discharge performance of the resultant Li/FeS₂ cells was evaluated by intermittently discharging the cells at the current of 16, 8, 4, 2 and 1 mA to the voltage cutoff of 0.9 V (the cells were rested for 2 h between the discharges). The capacities achieved from the discharges at each current are displayed in FIG. 5. For the purpose of comparison, the 2032 Li cells based on the uncoated FeS₂ electrode and a Celgard 2400 separator were assembled, and the discharge data of these cells are shown in FIG. 5 as well.

### Example 9

A 50 mm×120 mm piece of ˜2 mil-thick graphite electrode was placed onto a hot plate preheated with a surface temperature of 140° C. The electrode had a composition of (w/w) 86% graphite-7% PVDF -7% carbon black, supported on a 1.0 mil-thick Cu foil. When the surface temperature of the electrode reached 100° C., 2.6 g of the coating formulation described in Example 7 was sprayed onto the electrode using an H-type airbrush (Paasche Air Brush Company) under an air pressure of 15 psi. The coated electrode was subsequently transferred to a 100° C. oven and evacuated for 16 h to dry off solvent remaining in the electrode.

### Example 10

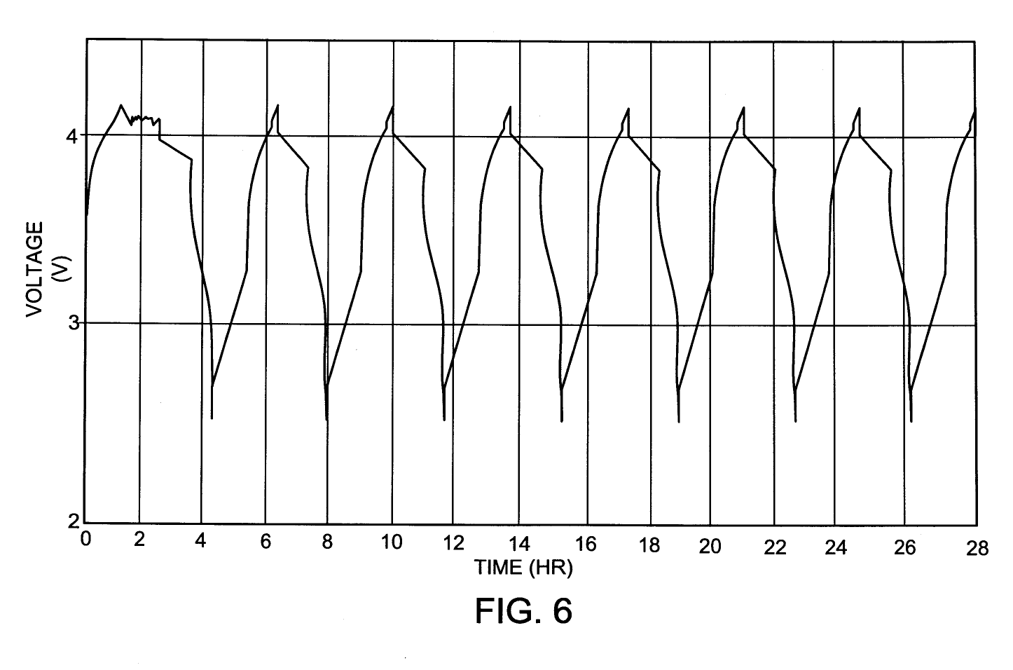

The electrochemical performance of the graphite electrode coated with the SIS/silica separator, described in Example 9, was evaluated in 2032 lithium-ion graphite/LiMn_{0.33}Ni_{0.33}Co_{0.33}Oₓ coin cells. The 2032 cells were assembled by laminating a piece of the coated graphite electrode (diameter: 9/16″) with one piece of LiMn_{0.33}Ni_{0.33}Co_{0.33}Oₓ electrode (diameter: 7/16″; composition: 86% LiMn_{0.33}Ni_{0.33}Co_{0.33}Oₓ-7% PVDF-7% carbon black) coated onto aluminum foil. An electrolyte of 1 M LiPF₆ in a mixture of ethylene carbonate and dimethyl carbonate (v/v=50/50) was used. The performance of the resultant 2032 graphite/LiMn_{0.33}Ni_{0.33}Co_{0.33}Oₓ cells was evaluated by charging/discharging the cells between 4.2 to 2.5 V at 2 mA; The cells were rested for 2 h before each charge and discharge. The charge/discharge data for one of the cells are displayed in FIG. 6, and in the table below:

| Cycle No. | Capacity (Charge)(mAh) | Capacity (Discharge)(mAh) |
|---|---|---|
| 1 | 4.78* | 1.63 |
| 2 | 1.6 | 1.49 |
| 3 | 1.68 | 1.59 |
| 4 | 1.7 | 1.62 |
| 5 | 1.74 | 1.66 |
| 6 | 1.75 | 1.67 |
| 7 | 1.72 | 1.65 |

A number of embodiments of the invention have been described. Nevertheless, it will be understood that various modifications may be made without departing from the spirit and scope of the invention.

For example, while applying the separator layer to the positive electrode is described above, in some cases the separator layer can be applied to the negative electrode. For instance, the separator layer may be applied to either electrode in Li-ion batteries, in which the anode is graphite, for example as illustrated in Examples 9 and 10.

Accordingly, other embodiments are within the scope of the following claims.

What is claimed is:

1. A method of forming a battery separator directly on an electrode, comprising spraying a solution or dispersion comprising silica particles and a polymer onto the electrode.

2. The method of claim 1 further comprising heating the electrode prior to spraying.

3. The method of claim 2 comprising heating the electrode to a temperature that is about 20 to 40° C. less than the melting point of the polymer.

4. The method of claim 2 wherein the solution comprises a solvent and the method further comprises evacuating to drive off residual solvent.

5. The method of claim 4 wherein evacuation is performed under vacuum, at a temperature that is about 20 to 60° C. lower than the melting point of the polymer.

6. The method of claim 1 further comprising, prior to spraying the solution or dispersion onto the electrode, spraying a dispersion consisting essentially of colloidal silica onto the electrode to form an underlying silica layer.
